(19) United States
(12) Patent Application Publication
(10) Pub. No.: US 2019/0235067 A1
(43) Pub. Date: Aug. 1, 2019

(54) MOVING OBJECT DETECTION METHOD IN REAL-TIME USING FMCW RADAR

(71) Applicant: WAVE3D CO.,LTD., Jeonnam (KR)

(72) Inventor: Kyung Sik SEO, Gwangju (KR)

(73) Assignee: WAVE3D CO.,LTD., Jeonnam (KR)

(21) Appl. No.: 16/195,759

(22) Filed: Nov. 19, 2018

(30) Foreign Application Priority Data
Jan. 31, 2018 (KR) 10-2018-0012249

(51) Int. Cl. G01S 13/536; G01S 13/56; G01S 7/35

(52) U.S. Cl. CPC G01S 13/536; G01S 2007/356; G01S 7/352; G01S 13/56

(57) ABSTRACT

The present invention relates to a moving object detection technique, and more particularly, to a real-time moving object detection method using a continuous wave radar that detects a moving object in real time using a Robust Principal Component Analysis through Gradient descent. An exemplary embodiment of the present invention provides a moving object detection method in real-time using FMCW radar comprising: collecting input data by extracting Fast Fourier Transform (FFT) information from a reflection signal received in a continuous wave radar in a detection region; preprocessing to perform compensation and correction on the collected input data; modeling a lower noise background using a Robust Principal Component Analysis through Gradient descents to separate a foreground moving objects corresponding to a noise background and a moving object from the preprocessed data; and detecting a position of a noise-free foreground moving objects by performing an Automatic Multiscale-Based Peak Detection (AMPD) after applying the Robust Principal Component Analysis (RPCA).

### CROSS-REFERENCE TO RELATED APPLICATION

This application claims the benefit of the Korean Patent Application No. 10-2018-0012249, filed on Jan. 31, 2018, which is hereby incorporated by reference as if fully set forth herein.

### FIELD OF THE INVENTION

The present invention relates to a moving object detection technique, and more particularly, to a moving object detection method in real-time using a continuous wave radar that detects a moving object in real time using a Robust Principal Component Analysis through Gradient descent.

### BACKGROUND OF THE RELATED ART

Recently, research is being conducted to detect moving objects using FMCW (Frequency Modulated Continuous Wave) radar.

Moving object detection is a common technique in many security systems. The most widely used solution for moving object detection is to use a camera to collect video and extract useful information to obtain the presence of a moving object in the video frame. However, the method of using the camera is largely influenced by changes in lighting and weather conditions. On the other hand, radar systems can operate independently from the effects of these condition changes and can result in high accuracy.

In general, radar systems are divided into two categories: shock radar and continuous wave radar. Among them, FMCW radar corresponding to the continuous wave radar is the best choice for estimating the distance and velocity of a moving object.

The range information for the detection of the moving object can be extracted through demodulation of the frequency signal and the speed of the moving object can be calculated based on the Doppler effect of the FMCW radar.

However, the problem with moving object detection technology is that radar accuracy is affected by complex environments. Moving object detection is often difficult due to noise from small moving objects, reflected signals from large fixed objects in the radar range, and multipath problems.

Various algorithms have been developed based on hardware and software structures to reduce the noise effects, in order to solve the problem of lowering the radar accuracy as described above.

First, based on the hardware configuration, a low-noise Colpitts VCO with a transformer-based resonator and 20˜40 GHz frequency band for 77˜81 GHz radar was introduced. [W. Wang, Y. Tohsuke, Y. Yeh, B. Floyd, “A 20 GHz VCO and frequency doubler for W-band FMCW radar applications,” in IEEE 14th Topical Meeting on Silicon Monolithich Integrated Circuits in Rf System (SiRF), Newport Beach, Calif., USA, USA, 2014, pp. 104-106.]

Another technique based on hardware configuration has been proposed to increase the linearity of the sweep frequency to eliminate the phase noise of the signal based on two broadband linear RF voltage controlled oscillators (VCOs). [M-T Dao, D-H Shin, Y-T Im, S-O Park (2013, January). A Two Sweeping VCO Source for Heterodyne FMCW Radar. IEEE Trans. Microwave Theory and Techniques pp. 230-239.]

In addition, a technique to compensate the nonlinearity of the VCO tuning rule by measuring the frequency of the divider signal has been introduced, and the delay locked loop (DLL) can be used to compensate the phase noise performance of the PLL and the linearity of the frequency sweep A technology to utilize it as a frequency multiplier for a reference signal has been introduced.

In order to improve the radar accuracy described above, the methods based on the hardware configuration could improve the accuracy of the radar parameters, but still had a disadvantage of costly hardware experiments.

A method for improving radar detection performance based on software algorithms uses a method for processing received data.

One is a technique that uses de-interleave method in the time domain and uses a different number of Fast Fourier Transform (FFT) samples to improve the detection results of range and velocity of the moving object. [E. Hyun, J-H Lee (2009, June). Method to Improve Range and Velocity Error Using De-interleaving and Frequency Interpolation for Automotive FMCW Radars.Journal of Signal processing, Image Processing and Patern Recognition.Volume 2, No. 2 pp. 11-22.]

Another methods based on the 2-D FFT using the fast-ramps training technique and the other methods based on the constant false alarm rate (CFAR) algorithm to reduce the effects of noise have also been applied, and an excellent waveform design solution has been applied to improve noise reduction and multi-target detection results. Additional method based on a machine learning technique for modeling the background and extracting the foreground motion technique using the Gaussian Mixture Model with the FMCW radar has also been proposed have.

Meanwhile, various approaches for solving the moving object detection problem have been studied. Among them, the sub-matrix decomposition algorithm based on the Robust Principal Component Analysis (RPCA) shows an impressive achievement in the background. [T. Bouwmans, A. Sobral, S. Javed, S. K. Jung, E-H. Zahzah (2017, February). Decomposition into Low-rank plus Additive Matrices for Background/Foreground Separation: A Review for a Comparative Evaluation with a Large-Scale Dataset. Journal of computer science reviewpp.1]

However, a major problem with RPCA placement optimization processing is the large computational time and large memory requirements. Such problems were solved by the Inactact Augmented Lagrange Multiplier (IALM) approach, which supports fast processing times. Recently, an online-robust PCA (OR-PCA) algorithm has been proposed that reduces processing time by processing one sample per hour based on probabilistic approximation. In addition, a new method for solving the RPCA problem using the Robust Principal Component Analysis through Gradient descents has been proposed, and the experiment thus proved to be effective in terms of accuracy as well as processing time have. [K X. Yi, D. Park, Y. Chen, C. Caramanis. Fast Algorithms for Robust PCA via Gradient Descent. 2016]

### SUMMARY OF THE INVENTION

It is an object of the present invention to provide a moving object detection method in real-time using a continuous wave radar that can effectively detect a moving object using an FMCW radar in a noisy environment based on RPCA.

It is another object of the present invention to provide a moving object detection method in real-time using a continuous wave radar with improved processing time and accuracy compared to the conventional RPCA-based approach in moving object detection.

### Technical Solution

An exemplary embodiment of the present invention provides a moving object detection method in real-time using FMCW radar comprising: collecting input data by extracting Fast Fourier Transform (FFT) information from a reflection signal received in a continuous wave radar in a detection region; preprocessing to perform compensation and correction on the collected input data; modeling a lower noise background using a Robust Principal Component Analysis through Gradient descents to separate a foreground moving objects corresponding to a noise background and a moving object from the preprocessed data; and detecting a position of a noise-free foreground moving objects by performing an Automatic Multiscale-Based Peak Detection (AMPD) after applying the Robust Principal Component Analysis (RPCA).

Preferably, the step of preprocessing include: using a time-based sliding window approach in which a window size is fixed to perform compensation and correction on the input data, accumulating a primitive data vector having the window size as an initialization matrix, after new data is input, updating a sub-component matrix used in the previous process by using a vector of the last column of newly input data as the initialization matrix while using the sub-component matrix again.

More preferably, the step of updating include: when updating the initialization matrix with the last column of newly input data, removing the oldest column in the previous process according to the sliding window approach.

Preferably, the step of detecting include: performing the Automatic Multiscale-Based Peak Detection (AMPD) based on a Local Maxima Scalogram (LMS) using the noise-free foreground moving objects an input for peak detection.

### Effects of the Invention

According to the present invention, it is possible to effectively perform moving object detection using an FMCW radar in a noisy environment based on RPCA.

Also, processing time and accuracy are improved compared to the conventional approach based on the RPCA by optimizing the size of the processing window and the number of processing iterations in the moving object detection.

### BRIEF DESCRIPTION OF THE DRAWINGS

FIG. 1 is a diagram illustrating a real-time moving object detection procedure using a continuous wave radar according to an embodiment of the present invention,

FIG. 2 is a diagram for explaining the time-based sliding window approach used in the present invention, and

FIG. 3 is a diagram for explaining an algorithm for Automatic Multiscale-Based Peak Detection (AMPD) according to the present invention.

### DETAILED DESCRIPTION OF THE PREFERRED EMBODIMENTS

Other objects, features, and advantages of the present invention will be apparent through a detailed description of exemplary embodiments referring to the accompanying drawings.

Hereinafter, a configuration and an operation of an embodiment of the present invention will be described with reference to the accompanying drawings and the configuration and the operation of the present invention illustrated and described in the drawings are described as at least one embodiment and the technical spirit of the present invention and a core configuration and an operation thereof are not limited thereto.

Hereinafter, a preferred embodiment of a moving object detection method in real-time using a FMCW radar according to the present invention will be described in detail with reference to the accompanying drawings.

The present invention comprises the steps of collecting input data, preprocessing to perform compensation and correction on the collected input data, modeling a lower noise background using RPCA through gradient descents, and detecting a position of a foreground moving objects by an automatic multiscale-based peak detection (AMPD) method.

All processing steps of the present invention are based on a sliding window approach.

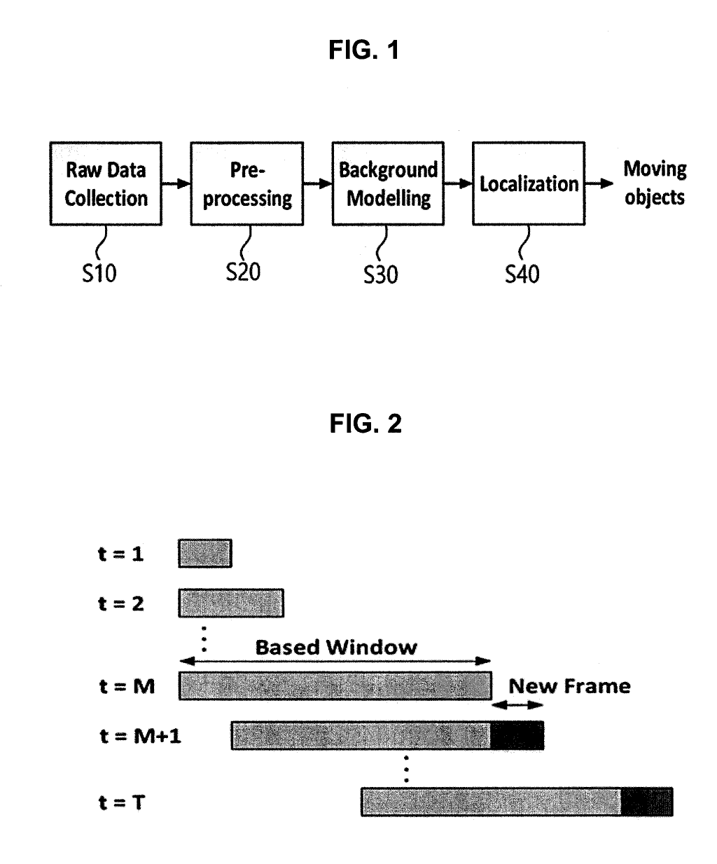

FIG. 1 is a diagram illustrating a real-time moving object detection procedure using a continuous wave radar according to an embodiment of the present invention. Here, the continuous wave radar may be an FMCW radar.

Referring to FIG. 1, the input data is collected using the FMCW radar (S10).

The distance from an object to the FMCW radar and the speed of the object can be estimated by Fast Fourier Transform (FFT) of the reflected signal from the moving object based on the Doppler effect.

The FMCW radar can use a radar signal at a frequency of 122 GHz, and the FMCW radar has one transmitting antenna (TX), one receiving antenna (RX) and a reflected signal measuring device. The reflected signal measuring device uses the SiRad Easy Radar Evaluation Kit and collects reflected signals from the detection area.

The reflected signal measuring device can set various parameters such as the bandwidth of the radar signal, the number of points of the FFT and the number of the ramps.

The reflected signal measuring device is connected to the computer via the UART port and transmits all data to the computer immediately. The output of the reflected signal measuring device is block unit data, and the data block accordingly includes system information, status information, FFT and constant false alarm rate (CFAR) data, object information and error information. Size, phase, and other information may be extracted from the output of the FFT. The object is also detected by the CFAR operator.

The data block can be extracted into different data frames in which the start and end bits are defined. In the present invention, only the FFT information is extracted from the received reflected signal. Accordingly, one FFT data frame can be extracted for each period.

The FFT data frame is stored as a column vector (Xₜϵ [symbol] ^{N×1}) with N elements. After a T period, the received signal is stored as a ellipse matrix (Xϵ [symbol] ^{N×T}). All data is recorded for further comparison and processed using the Matlab programming language.

To accurately calculate the distance to the bin file for each FFT, use a corner cube (RCS=1 m²) and tape measure to correct the input data.

In the present invention, a time-based sliding window approach is used to process input data. FIG. 2 is a diagram for explaining the time-based sliding window approach used in the present invention.

Referring to FIG. 2, fixing window size M and processing it in window matrix Y E [symbol] ^{N×M}. In the present invention, when using the sliding window approach, the window size M can be fixed, preferably M=50. As another example, the window size may vary from 30 to 90.

In the present invention, for processing in the initialization matrix, a primitive data vector of M is accumulated as the initialization matrix, thereafter, when a new data frame is input, it is added to the processing matrix. At this time, the oldest data frame is not processed, and a new data frame is processed. In the present invention, when each new data frame is accumulated, the initial background for the RPCA is updated.

After compensating and correcting the input data frame, the noise background is modeled using RPCA through Radient descents (S20).

Theoretically, the radar equation shows the relationship between the received signal power and the transmitted signal power as follows (1).

$$\frac{{P}_{r}}{{P}_{t}} = \frac{{G}_{t} {A}_{e} σ}{{( 4 π )}^{2} {R}^{4}} \qquad ( 1 )$$

Where Pr is the received signal power, Pt is the transmitted signal power, Gt is the gain of the antenna, σ is the cross section of the radar, and R is the object (distance from the radar to the object).

The received signal power, which decreases when the object moves away from the radar, can be called path loss compensation.

To compensate for the radar signal, a Corner Cube is used to estimate the relationship between signal power and range.

log₁₀(4πR²) is selected as the compensation factor, and the received signal power vector at each point of the FFT has a weight log₁₀(4πR²). Where R is the range between the radar and the specific location. In addition, a bandpass filter is applied to reduce the influence of noise in the environment.

Thereafter, the compensated signal includes only the fixed object and the signal reflected from the moving object.

Next, in order to separate the background and the moving object, the background is modeled using RPCA (S30).

The main purpose of RPCA is to decompose the observation matrix X ϵ [symbol] ^{N×T} into a matrix L with rank r and a sparse component matrix S.

The object is modeled by the sparse component matrix S ϵ [symbol] ^{N×T}, and the background is modeled by the sub-component matrix L ϵ [symbol] ^{N×T}. In the present invention, L and S are restored from the observation matrix X using the convex relaxation of the following equation (5).

min_{L,S}∥L∥_{*}+λ∥S∥₁,s.t. X=L+S, (5)

In the above equation (5), ∥L∥_{*}is the nuclear norm of the matrix L, ∥S∥₁=Σ_{i,j}|Sᵢⱼ| and λ is a positive weight parameter.

In order to process equation (5), the present invention uses a sliding window approach. That is, when a new frame is input, the sub-component matrix is slightly changed as compared with the previous one. Therefore, the sub-component matrix in the previous process is used again and the vector of the last column is used as the initialization matrix for optimization.

More specifically, data to be processed up to t=M is collected. When t=M, Gradient descents RPCA is used to extract sub-components.

The initialization matrix (Sᵢₙᵢₜ) of the sparse component matrix is generated based on the input window matrix Y. Here, the input window matrix Y uses an alignment based sparse estimation algorithm (Phase 1). The alignment algorithm is basically performed by the following equation (6) for any matrix A ϵ [symbol] ^{d1×d2}.

$${𝒯}_{α} [ A ] := \{ \begin{matrix}{A}_{( i , j )} , & if \vert {A}_{( i , j )} \vert \geq \vert {A}_{( i , . )}^{( α d 2 )} \vert and \vert {A}_{( i , j )} \vert \geq \vert {A}_{( . , j )}^{( α d 1 )} \vert \\ 0 , & otherwise\end{matrix} \qquad ( 6 )$$

In the equation (6), A_{(i,.)}^{(k)} and A_{(.,j)}^{(k)} provide the components of A_{(i,.)} and A_{(.,j)} with k-th magnitude, respectively.

After generating the initialization matrix (Sᵢₙᵢₜ) of the sparse component matrix, obtain the matrix rank r from the equation [H, Σ, K]=SVD (Y−Sᵢₙᵢₜ) by applying a SVD (single-valued decomposition) method to Y−Sᵢₙᵢₜ. Here, Uₜ←HΣ^{1/2} and Vₜ←KΣ^{1/2}.

Thereafter, given Uₜ and Vₜ, the present invention implements an iterative process of generating a sparse component matrix S based on the sparse estimator for (Y−UₜVₜ′). As a result, the Projected Gradient descents method is executed to generate new U_{new} and V_{new}.

On the other hand, in the present invention, the optimization problem of the following equation (7) is considered.

$${min}_{U ∈ 𝒰 , V ∈ 𝒱 , S ∈ {𝒮}_{α}} ℒ ( U , V , S ) + \frac{1}{8} {\vert \vert {U}^{T} U - {V}^{T} V \vert \vert}_{F}^{2} \qquad ( 7 )$$

The projected gradient descents method is calculated according to the following equation (8) (Phase 2).

$${U}_{new} = {Π}_{𝒰} ( {U}_{t} - η {∇}_{U} ℒ ( {U}_{t} , {V}_{t} ; {S}_{t} ) - \frac{1}{2} η {U}_{t} ( {U}_{t}^{T} {U}_{t} - {V}_{t}^{T} {V}_{t} ) ) \\ {V}_{new} = {Π}_{V} ( {V}_{t} - η {∇}_{V} ℒ ( {U}_{t} , {V}_{t} ; {S}_{t} ) - \frac{1}{2} η {V}_{t} ( {V}_{t}^{T} {V}_{t} - {U}_{t}^{T} {U}_{t} ) ) \qquad ( 8 )$$

Here, a is a model parameter, y and q are algorithm tuning parameters, and L (U, V, S) is a loss function defined by the following equation (9).

$$ℒ ( U , V , S ) := \frac{1}{2} {\vert \vert {UV}^{T} + S - Y \vert \vert}_{F}^{2} \qquad ( 9 )$$

Finally, the sub-component matrix and the sparse component matrix are updated (Phase 3).

Subsequently, when a new frame is continuously input, the initial Uₜ and Vₜ are updated from the frame t=M+1. At this time, the oldest column is removed according to the sliding window approach.

The present invention discards the oldest vector of Uₜ and Vₜ and update Uₜ and Vₜ by adding the previous sub-vector to the last column. The updated matrices Uₜ and Vₜ are used for initialization for optimization based on the Gradient descents method. Accordingly, processing time for optimizing Uₜ and Vₜ can be saved.

Subsequently, the aforementioned Phase 2 and Phase 3 are performed again.

Next, the position of the moving object is detected (S40).

After applying the RPCA, the noise-free signal is used as the input to the peak detection to detect the position of the moving object.

In the present invention, an AMPD (Automatic Multiscale-Based Peak Detection) algorithm is applied for peak detection. The AMPD algorithm is based on the local maxima scalogram (LMS).

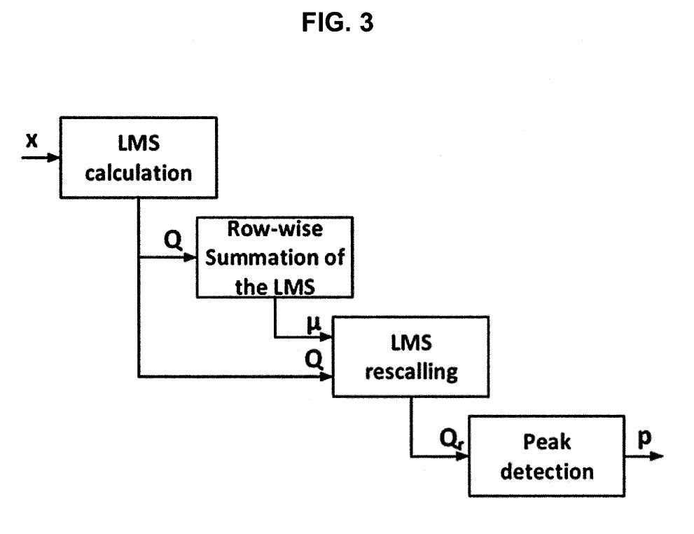

FIG. 3 is a diagram for explaining an algorithm for Automatic Multiscale-Based Peak Detection (AMPD) according to the present invention.

In FIG. 3, x is the input vector signal, Q is the LMS of the signal vector x, μ contains information about the distribution of zeros dependent on size, Qᵣ is the variance of the matrix Q based on μ, p is the detected peak.

In the present invention, multiple values having an average value of all detected peak values and a factor ε=2.5 are calculated. The result is regarded as a threshold value for each processing frame, and a detection point having a value larger than the threshold value corresponds to a moving object.

Although preferred embodiments of the present invention have been described up to now, those skilled in the art will be able to implement in a modified form within a scope without departing from an essential characteristic of the present invention.

Therefore, the exemplary embodiments of the present invention described herein need to be considered from a limited viewpoint but an explanatory viewpoint and the scope of the present invention is shown in not the description but the claims and it should be interpreted that all differences within the scope equivalent thereto are included in the present invention.

What is claimed is:

1. A moving object detection method in real-time using FMCW radar comprising:
collecting input data by extracting Fast Fourier Transform (FFT) information from a reflection signal received in a continuous wave radar in a detection region;
preprocessing to perform compensation and correction on the collected input data;
modeling a lower noise background using a Robust Principal Component Analysis through Gradient descents to separate a foreground moving objects corresponding to a noise background and a moving object from the preprocessed data; and
detecting a position of a noise-free foreground moving objects by performing an Automatic Multiscale-Based Peak Detection (AMPD) after applying the Robust Principal Component Analysis (RPCA).

2. The method as claimed in claim 1, the step of preprocessing include,
using a time-based sliding window approach in which a window size is fixed to perform compensation and correction on the input data,
accumulating a primitive data vector having the window size as an initialization matrix,
after new data is input, updating a sub-component matrix used in the previous process by using a vector of the last column of newly input data as the initialization matrix while using the sub-component matrix again.

3. The method as claimed in claim 2, the step of updating include,
when updating the initialization matrix with the last column of newly input data, removing the oldest column in the previous process according to the sliding window approach.

4. The method as claimed in claim 1, the step of detecting include,
performing the Automatic Multiscale-Based Peak Detection (AMPD) based on a Local Maxima Scalogram (LMS) using the noise-free foreground moving objects an input for peak detection.
